(19) United States
(12) Patent Application Publication
(10) Pub. No.: US 2009/0313276 A1
(43) Pub. Date: Dec. 17, 2009

(54) Process and device for data conversion, and computer-readable recording medium storing data conversion program

(75) Inventor: Yoshiro Wataguchi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/453,064

(22) Filed: Apr. 28, 2009

(30) Foreign Application Priority Data
Jun. 17, 2008 (JP) 2008-157538

(51) Int. Cl. G06F 17/30

(52) U.S. Cl. 707/101; 707/E17.009

(57) ABSTRACT

In a data conversion device for converting data for use in a first-stage service provision unit and a second-stage service provision unit which performs processing in response to a request from the first-stage service provision unit, first converted data is generated by converting one or more special characters included in the input data into one or more neutral characters on basis of neutral-character conversion information stored in a neutral-character conversion storage, and outputted to the first-stage service provision unit; and all or part of one or more neutral characters included in processed data generated by the first-stage service provision unit are each converted into a string of one or more safe characters on the basis of safe-character conversion information stored in a safe-character conversion storage, and outputted to the second-stage service provision unit.

### CROSS-REFERENCE TO RELATED APPLICATIONS

This application is based upon and claims the benefits of priority from the prior Japanese Patent Application No. 2008-157538, filed on Jun. 17, 2008, the entire contents of which are incorporated herein by reference.

### FIELD

The present invention relates to a data conversion device, a data conversion process, and a computer-readable recording medium in which a data conversion program is recorded.

### BACKGROUND

Currently, systems in which a server provides various services to clients through a network such as the Internet are widely used. In such systems, for example, a web server which executes web applications is used as the above server. The web applications transmit to a client a web page described in HTML (Hyper Text Markup Language) and the like by use of HTTP (HyperText Transfer Protocol), and provide to the client a unified interface for a plurality of services. In addition, the web applications perform processing in response to a request received from the client, and transmits a response to the client.

The request transmitted from the client includes a parameter indicating information on the client (such as cookie values, POST values, or the like). Such a parameter is used, for example, in processing by a web application, or in a command returned from a web application to another system (e.g., a database system) linked with the web application. When the system linked with the web application is a database system, the web application produces an SQL (Structured Query Language) statement for accessing the database system according to processing requested by the client. Further, the web application transmits to the browser of the client a response which indicates a result of processing requested by the client in the form of an HTML document or the like.

In many cases, a response to a browser or a command in the form of an SQL statement which are produced by the web applications contain a parameter which is contained in a request transmitted from a client, as it is. Therefore, there is a week point that an operation which is not expected in the browser of the client or the database system can be caused when the parameter contains an unauthorized command described with a script or an SQL statement. For example, cross-site scripting (XSS) and SQL injection are known as attacking techniques which intentionally abuse the above week point.

When a web application transmits to a client an HTML document as a response containing an unauthorized script which is contained in an inputted parameter, as it is, and then a browser executes the unauthorized script, the cross-site scripting occurs. When the client receives the cross-site scripting attack, the client can suffer from spoofing or stealing, by a third party, of inputted personal information or cookie information.

When a web application transmits to a database system an SQL sentence containing an unauthorized command which is contained in an inputted parameter, as it is, and then the database system executes the unauthorized command, the SQL injection occurs. When the database system receives the SQL injection attack, the database system can allow unauthorized access, and suffer from leakage or falsification of information registered in the database system.

Therefore, there are demands for taking sufficient security measures to the above attacks so as to secure safety in use of the system. In order to prevent the above attacks, conventionally, techniques of correctly performing escape processing of control characters which are contained in the parameter and can realize an unauthorized command are used.

According to one of the above techniques of performing escape processing, a web-application firewall (WAF) is arranged between a client and a server for relaying requests. In the case where the WAF is used, it is possible to examine each parameter contained in a request, and eliminate invalid characters contained in the request by performing escape processing of the invalid characters or rejecting the request before the request reaches the web server. However, since the WAF examines the request before the request reaches the web server, it is difficult to take measures according to the attacking manner. For example, when the WAF is configured to finely examine requests for the cross-site scripting, the SQL injection, and the like on the basis of an identical criterion, some requests which are valid for one or more destinations of the outputs of the web server can be rejected by the WAF.

According to a first known technique proposed for overcoming the above problem with the provision of the WAF, characters to be examined are registered in advance for each of different types of attacks including the cross-site scripting, the SQL injection, and the like, and the characters to be examined are read out according to the destination of each of HTML documents, SQL statements, and the like, so that it is possible to achieve fine examination and escaping for each destination. (See, for example, Japanese Laid-open Patent Publications Nos. 2007-047884 and 2004-533676.) According to a second known technique proposed for overcoming the aforementioned problem with the provision of the WAF, in order to appropriately make settings for escaping according to the destination, a trace value for examination is inserted into each request before transmission to a web application, and the destination of each parameter is examined in advance on the basis of the trace value contained in the response. (See, for example, Japanese Laid-open Patent Publications Nos. 2004-164617 and 2007-004685.) According to a third known technique proposed for overcoming the aforementioned problem with the provision of the WAF, a web application encrypts each command described with an SQL statement, and the encrypted command is decrypted by a proxy server before a database is accessed. (See, for example, S. W. Boyd and A. D. Keromytis, “SQLrand: Preventing SQL Injection Attacks,” In Proceedings of the 2nd International Conference on Applied Cryptography and Network Security (ACNS), June 2004, pp. 292-302.) In the case where the third known technique is used, even when a request contains a parameter containing an unauthorized SQL command, the unauthorized SQL command cannot be decrypted unless the unauthorized SQL command is properly encrypted. Therefore, it is possible to prevent the SQL injection attack.

According to a fourth known technique proposed for overcoming the aforementioned problem with the provision of the WAF, a web application produces an SQL statement after the parameter portion contained in a request from a client is encrypted, and then the web application accesses a database. (The fourth known technique is published by, for example, Fumiaki Nagano et al., “Method of Protecting Against SQL Injection Attack by Encrypting Value Inputted by User,” Computer Security Symposium 2006 (CSS 2006), Information Processing Society of Japan, October 2006.) In the case where the fourth known technique is used, even when the parameter portion contains an unauthorized SQL statement, the unauthorized SQL statement is recognized merely as an encrypted character string during SQL execution. Therefore, it is possible to prevent execution of the unauthorized SQL statement.

However, according to the aforementioned first and second known techniques disclosed in Japanese Laid-open Patent Publications Nos. 2007-047884, 2004-533676, 2004-164617, and 2007-004685, settings are required to be made for all the characters subject to the escape processing according to the destinations of HTML documents, SQL statements, and the like. Therefore, omission is likely to occur in the settings for the characters subject to the escape processing, so that the system can suffer from the attack.

Further, in the case where the aforementioned third known technique disclosed by Boyd et al. or the fourth known technique disclosed by Nagano et al. is used, the system is greatly affected, for example, by arrangement of the proxy server for decrypting the encrypted command, the encryption of information registered in the database, or other provision. In addition, it is necessary to manage the use of the key for encryption and decryption. If the key is stolen, the database can be unauthorizedly accessed by a third party. That is, when cryptography is used, the burden imposed on the server administrator becomes excessively heavy. Therefore, a technique for securing high safety from SQL injection attack and the like by use of the escape technology is demanded, since the escape processing imposes a relatively light burden on the server administrator.

### SUMMARY

In order to solve the above problems, a data conversion device for converting data for use in one or more first-stage service provision units and a second-stage service provision unit which performs processing in response to a request from one of the one or more first-stage service provision units is provided. The data conversion device includes: a neutral-character conversion storage which stores neutral-character conversion information indicating correspondence of one or more special characters with one or more neutral characters which are predetermined and used by none of the one or more first-stage service provision units and the second-stage service provision unit; a safe-character conversion storage which stores safe-character conversion information indicating correspondence of each of one or more neutral characters with a predetermined string of one or more safe characters which is to be used for character reference by the second-stage service provision unit; a first conversion unit which receives input data, generates first converted data by converting one or more special characters included in the input data into one or more neutral characters on the basis of the neutral-character conversion information stored in the neutral-character conversion storage, and outputs the first converted data to the one of the one or more first-stage service provision units; and a second conversion unit which receives processed data generated by the one of the one or more first-stage service provision units by processing of the first converted data, generates second converted data by converting each of all or part of one or more neutral characters included in the processed data into a string of one or more safe characters on the basis of the safe-character conversion information stored in the safe-character conversion storage, and outputs the second converted data to the second-stage service provision unit.

The objects and advantages of the invention will be realized and attained by means of the elements and combinations particularly pointed out in the claims.

It is to be understood that both the forgoing general description and the following detailed description are exemplary and explanatory and are not restrictive of the invention, as claimed.

### BRIEF DESCRIPTION OF DRAWINGS

FIG. 1 illustrates an outline of an embodiment;

FIG. 2 illustrates a configuration of a web system according to the embodiment;

FIG. 3 illustrates an example of a hardware construction of a web server;

FIG. 4 is a block diagram illustrating the functions of the web server;

FIG. 5 illustrates an example of a data structure of a neutral-character conversion table;

FIG. 6 illustrates an example of a data structure of a special-character restoration table;

FIG. 7 illustrates an example of a data structure of a safe-character conversion table for HTML;

FIG. 8 illustrates an example of a data structure of a safe-character conversion table for SQL;

FIG. 9 illustrates an example of a data structure of a safe-character conversion table for e-mails;

FIG. 10 is a flow diagram indicating a sequence of data conversion processing;

FIG. 11 is a flow diagram indicating an exemplary sequence of processing for conversion of one or more special characters into one or more neutral characters;

FIG. 12 is a flow diagram indicating an exemplary sequence of processing for restoration of one or more special characters from one or more neutral characters;

FIG. 13 is a flow diagram indicating an exemplary sequence of processing for conversion of one or more neutral characters into one or more safe-character strings;

FIG. 14 is a diagram schematically indicating data flows in an example of data conversion processing;

FIG. 15 is a diagram indicating a concrete example of conversion of special characters into neutral characters;

FIG. 16 is a diagram indicating a concrete example of restoration of special characters from neutral characters;

FIG. 17 is a diagram indicating a first concrete example of conversion of neutral characters into safe-character strings;

FIG. 18 is a diagram indicating a second concrete example of conversion of neutral characters into safe-character strings; and

FIG. 19 is a diagram indicating a third concrete example of conversion of neutral characters into safe-character strings.

### DESCRIPTION OF EMBODIMENT

An embodiment will be explained below with reference to the accompanying drawings, wherein like reference numbers refer to like elements throughout. First, an outline of the embodiment is explained, and thereafter details of the embodiment are explained.

### 1. Outline of Embodiment

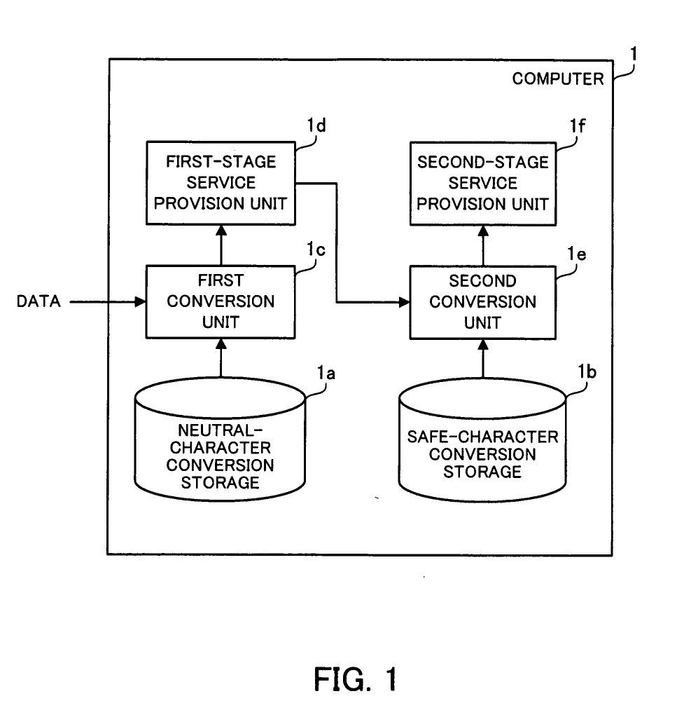

FIG. 1 illustrates an outline of the embodiment. The computer 1 executes a data conversion program according to the present embodiment, so that the computer 1 realizes a data conversion device having a neutral-character conversion storage 1a, a safe-character conversion storage 1b, a first conversion unit 1c, and a second conversion unit 1e. The data conversion device according to the present embodiment converts data for use in a first-stage service provision unit 1d and a second-stage service provision unit 1f. The second-stage service provision unit if performs processing in response to a request from the first-stage service provision unit 1d. Although the first-stage service provision unit 1d and the second-stage service provision unit 1f are indicated in the block of the one or more computers 1 in FIG. 1, each of the first-stage service provision unit 1d and the second-stage service provision unit 1f may be realized by a computer separately from the computer 1 realizing the data conversion device. Further, the neutral-character conversion storage 1a, the safe-character conversion storage 1b, the first conversion unit 1c, and the second conversion unit 1e may be realized by a computer separately from the computer 1.

The neutral-character conversion storage 1a stores neutral-character conversion information indicating correspondence of one or more special characters with one or more predetermined neutral characters which are used by neither of the first-stage service provision unit 1d and the second-stage service provision unit 1f. The neutral characters are characters represented by character codes which are used by neither of the first-stage service provision unit 1d and the second-stage service provision unit 1f. For example, the neutral characters include private-use characters and the like.

The safe-character conversion storage 1b stores safe-character conversion information indicating correspondence of each of the one or more neutral characters with a predetermined string of one or more safe characters (safe-character string) which is to be used for character reference by the second-stage service provision unit 1f. The correspondence of each of the one or more neutral characters with the safe-character string is defined in advance according to a control character which is used in processing performed by the second-stage service provision unit 1f.

When data is inputted into the first conversion unit 1c, the first conversion unit 1c generates first converted data by converting one or more special characters included in the inputted data into one or more neutral characters on the basis of the neutral-character conversion information stored in the neutral-character conversion storage 1a. Then, the first conversion unit 1c outputs the first converted data to the first-stage service provision unit 1d.

The first-stage service provision unit 1d performs processing based on the first converted data acquired from the first conversion unit 1c. The first-stage service provision unit 1d can perform the processing in cooperation with the second-stage service provision unit 1f, and generates processed data corresponding to the first converted data and containing a command for the second-stage service provision unit 1f to perform processing. Then, the first-stage service provision unit 1d outputs the processed data to the second conversion unit 1e. The first-stage service provision unit 1d is realized by, for example, a web application.

When the second conversion unit 1e acquires from the first-stage service provision unit 1d the processed data corresponding to the first converted data, the second conversion unit 1e generates second converted data by converting each of all or part of one or more neutral characters included in the processed data into a string of one or more safe characters (safe-character string) on the basis of the safe-character conversion information stored in the safe-character conversion storage 1b. Then, the second conversion unit 1e outputs the second converted data to the second-stage service provision unit 1f.

The second-stage service provision unit 1f performs processing based on the second converted data acquired from the second conversion unit 1e. The second-stage service provision unit 1f is, for example, a database (DB) system.

As explained above, the data conversion device according to the present embodiment performs conversion processing of inputted data in two stages. In the first stage, all the special characters contained in the inputted data are converted into neutral characters. Therefore, even when the inputted data contains an unauthorized command, the entire command can be converted into a string of one or more safe characters. In the second stage, each of all or part of one or more neutral characters contained in the processed data (outputted from the first-stage service provision unit 1d) is converted into a safe-character string according to the processing to be performed by the second-stage service provision unit 1f. In other words, in the conversion processing in the second stage, only the all or part of the one or more neutral characters which can be used by the second-stage service provision unit 1f, among the safe, neutral characters generated by the conversion in the first stage, are converted again. Therefore, even when omission occurs in the settings for escaping, the processed data supplied to the second-stage service provision unit 1f does not contain an unauthorized character string. Thus, it is possible to achieve high security in the system according to the present embodiment. Further, the conversion processing in the second stage can be realized by merely registering in advance in the safe-character conversion storage 1b information on the safe-character strings which can be used in the processing by the second-stage service provision unit 1f. Therefore, necessary information can be easily set.

### 2. Details of Embodiment

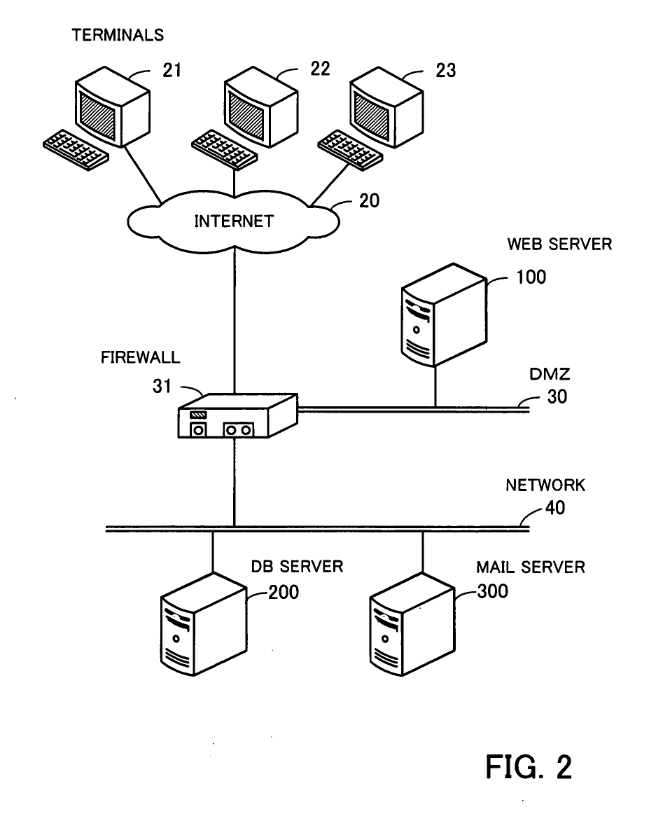

The technique explained above with reference to FIG. 1 is particularly useful in web services provided through the Internet. Therefore, details of the present embodiment are explained below with reference to FIGS. 2 to 19 by taking an example of a web system (using the Internet) to which the technique explained with reference to FIG. 1 is applied.

### 2.1 Configuration of Web System

FIG. 2 illustrates a configuration of a web system according to the embodiment. The web system of FIG. 2 provides to registered users a service of transmitting and receiving e-mails and messages for message boards through the Internet 20. In the configuration of FIG. 2, a web server 100 is connected to a network 30, which belongs to a demilitarized zone (DMZ). In addition, a DB (database) server 200 and a mail server 300 are connected to a network 40.

The networks 30 and 40 are connected through a firewall 31, and the network 30 and the Internet 20 are also connected through the firewall 31. The network 30 can be directly connected to the Internet 20 for performing communication through the Internet 20, while the network 40 is an internal network which can be indirectly connected to the Internet 20 for performing communication through the Internet 20. The firewall 31 controls IP (Internet protocol) communication between the networks 30 and 40, and maintains the security of the network 40. Further, the terminals 21, 22, and 23, which are clients using the web system, are connected to the Internet 20.

The web server 100 executes web applications which realize the functions of the services to be provided to the terminals 21, 22, and 23. In addition, the web server 100 provides to the terminals 21, 22, and 23 an interface for using the web applications, where the interface is, for example, a web page described with an HTML document. Specifically, when the web server 100 receives a request from one of the terminals 21, 22, and 23, the web server dynamically generates a response to the request, where the response is described with an HTML document or the like, and contains a web page using a parameter contained in the request. Then, the response is transmitted by HTTP from the web server 100 to the terminal, and executed by the browser of the terminal, so that the contents of the response are outputted to the user of the terminal. (Hereinafter, the browser means the browser of one of the terminals 21, 22, and 23.)

The user of each-of the terminals 21, 22, and 23 can receive the services provided by the web applications by transmitting to the web server 100 a request indicating details of processing which the user requests, where the request can be transmitted to the web server 100 by the user manipulating the terminal according to the information displayed on the web page.

The DB server 200 is a database system which stores and manages user information in the web system. Specifically, the DB server 200 stores data which are used in the services provided by the web server 100. When a command (with an SQL statement) is transmitted from one of the web applications in the web server 100 to the DB server 200, the DB server 200 performs processing according to the command, where the processing performed by the DB server 200 includes responding to an inquiry about the user information, updating of the user information, and the like. For example, the ID and the password of each user are registered in the DB server 200.

The mail server 300 is a server which performs processing such as reception, transmission, and storage of e-mails produced by the users of the web system. For example, when the mail server 300 receives a command from a web application in the web server 100, the mail server 300 performs processing for transmitting an e-mail on the basis of the command. In the following explanations, the DB server 200 and the mail server 300 may be generally referred to as transaction servers.

### 2.2 Functions of Web Application

Hereinbelow, examples of functions realized by web applications executed by the web server 100 are explained. For example, the web applications check an ID and a password presented by a user, perform login processing for letting the user log in to the web system, and provide to the normally-logged-in users services of transmitting and receiving e-mails and messages for message boards.

When the web applications receive a request transmitted from a terminal, the web applications generate a response being described with an HTML document or the like and including a parameter contained in the request, and transmit the response to the terminal which transmits the request. (For example, the response includes information for displaying a screen after a message is inputted into a message board.)

In addition, the web applications perform processing in cooperation with the DB server 200 or the mail server 300 in response to a request from a terminal. In such a case, the web applications generate a command for the DB server 200 or the mail server 300 to perform the processing. For example, when the web applications perform login processing, the web applications refer to the user information registered in the DB server 200. In this case, the web applications generate an SQL statement for performing the processing by the DB server 200. In the following explanations, commands to be executed by the transaction servers, which are generated by the web server, are also regarded as responses.

When the web applications generate a response to a request transmitted from one of the terminals 21, 22, and 23, the web applications insert into the response a parameter (such as user information) which is contained in the request. In this case, when the parameter acquired from the client contains an unauthorized script or an unauthorized SQL command, the web server 100 can receive an attack of cross-site scripting (XSS), SQL injection, or the like. However, the web server 100 according to the present embodiment prevents the above attack by appropriately performing escape processing on the above parameter. Further details of the construction and the functions of the web server 100 are explained below.

### 2.3 Hardware of Web Server

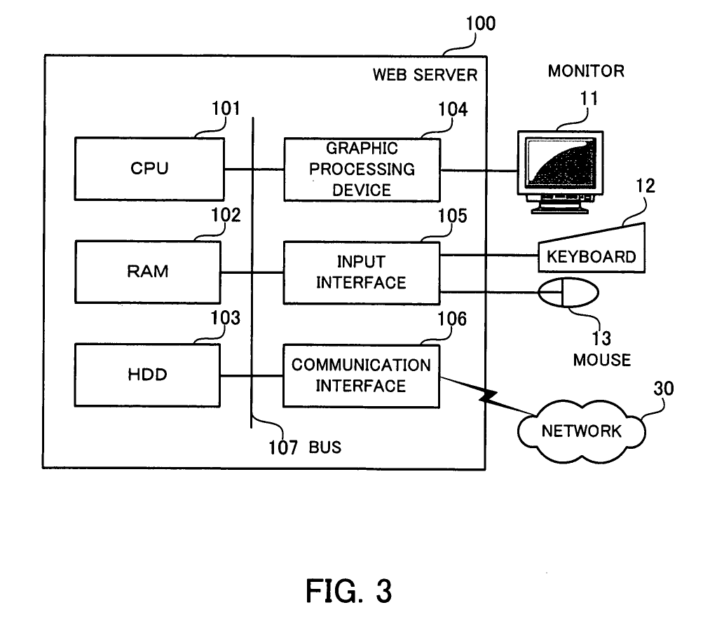

FIG. 3 illustrates an example of a hardware construction of the web server. The entire web server 100 is controlled by a CPU (central processing unit) 101, to which a RAM (random access memory) 102, a HDD (hard disk drive) 103, a graphic processing unit 104, an input interface 105, and a communication interface 106 are connected through a bus 107. The RAM 102 temporarily stores at least portions of an OS (operating system) program and application programs which are executed by the CPU 101, as well as various types of data necessary for processing by the CPU 101. The HDD 103 stores the OS program, the application programs, and various data necessary for processing by the CPU 101. A monitor 31 is connected to the graphic processing unit 104, which makes the monitor 31 display an image on a screen in accordance with an instruction from the CPU 101. A keyboard 32 and a mouse 33 are connected to the input interface 105, which transmits signals sent from the keyboard 32 and the mouse 33, to the CPU 101 through the bus 107. The communication interface 106 is connected to the network 30, and exchanges data with the firewall 31, the terminals 21, 22, and 23, and other servers. In addition, each of the terminals 21, 22, and 23, the DB server 200, and the mail server 300 can also be realized with a similar hardware construction.

### 2.4 Functions of Web Server

Next, the functions of the web server are explained in detail below. (Hereinafter, the functions and operations of the present embodiment are explained by taking an example where only the terminal 21 communicates with the web server 100. However, the system according to the present embodiment can similarly operate even when the other terminals communicate with the web server 100.)

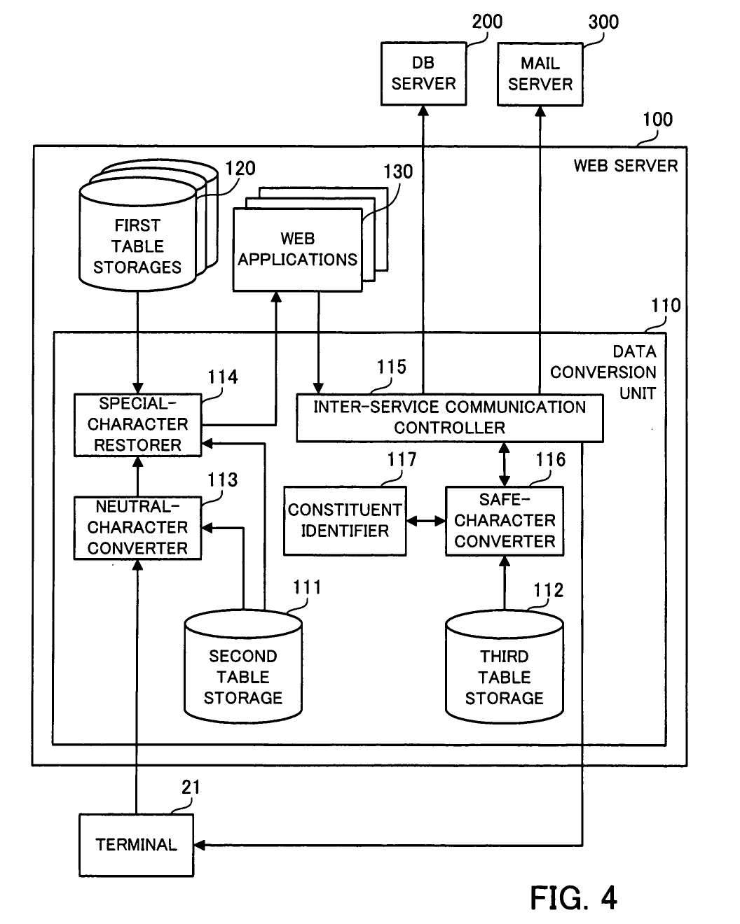

FIG. 4 is a block diagram illustrating the functions of the web server. The terminal 21 is connected to the web server 100 through the Internet 20. In addition, the DB server 200 and the mail server 300 are connected to the web server 100 through the networks 30 and 40.

The web server 100 comprises a data conversion unit 110, one or more first table storages 120, and one or more web applications 130, where the one or more first table storages 120 store one or more special-character restoration tables. The data conversion unit 110 relays requests and responses between the terminal 21 and the one or more web applications 130, and between the one or more web applications 130 and the transaction servers. The data conversion unit 110 according to the present embodiment converts character strings contained in the relayed requests and responses as needed. The data conversion unit 110 comprises a second table storage 111 storing a neutral-character conversion table, a third table storage 112 storing one or more safe-character conversion tables, a neutral-character converter 113, a special-character restorer 114, an inter-service communication controller 115, a safe-character converter 116, and a constituent identifier 117, where the second table storage 111 stores a neutral-character conversion table, and the third table storage 112 stores one or more safe-character conversion tables.

The neutral-character conversion table stored in the second table storage 111 indicates correspondence of special characters with neutral characters. The special characters are characters which exert special actions on the processing performed in the transaction servers or the browser, and include, for example, the symbols “&”, “<”, and the like. The neutral characters are characters which are not used in the processing performed by the one or more web applications, the browser, and the transaction servers. For example, in the case where Unicode is used as the character code system, characters defined in the private-use area can be used as the neutral characters. Alternatively, it is possible to use as the neutral characters other characters (e.g., the Ogam characters) which are considered not to be used in the processing performed by the one or more web applications, the browser, and the transaction servers. In the following explanations, it is assumed that Unicode is used as the character code system.

Each safe-character conversion table stored in the third table storage 112 indicates correspondence of each of the neutral characters with a string of one or more safe characters (safe-character string) for character reference which is usable in the processing performed by each of the browser and the transaction servers. The safe-character strings for character reference usable by each of the browser and the transaction servers are character strings for escaping which can be used in the processing performed by each of the DB server 200 and the mail server 300. For example, when the symbol “&” is required to be outputted, a safe-character string “&amp;” corresponding to the symbol “&” is described in an HTML document.

When the web server 100 receives a request from the terminal 21, the neutral-character converter 113 refers to the neutral-character conversion table stored in the second table storage 111, converts one or more special characters included in each parameter contained in the received request, into one or more neutral characters, and outputs to the special-character restorer 114 the request (converted request) in which the one or more special characters included in each parameter are converted into the one or more neutral characters.

The special-character restorer 114 acquires the converted request from the neutral-character converter 113, and determines one of the one or more web applications 130 as the destination of the request. Then, the special-character restorer 114 acquires a special-character restoration table corresponding to the determined web application from the one or more first table storages 120, and restores one or more special characters from all or part of the neutral characters contained in the converted request on the basis of the acquired special-character restoration table and the neutral-character conversion table stored in the second table storage 111, where the one or more restored special characters are one or more special characters which are necessary in the processing performed by the determined web application. The one or more special characters which are necessary in the processing performed by each web application are defined in advance, and set in the special-character restoration table corresponding to the web application. Finally, the special-character restorer 114 outputs to the determined web application the restored request (i.e., the request in which the one or more special characters are restored).

The inter-service communication controller 115 acquires responses, which are generated by the one or more web applications 130 and are to be transmitted to one of the browser and the transaction servers. Then, the inter-service communication controller 115 outputs the acquired responses to the safe-character converter 116. Thereafter, the inter-service communication controller 115 acquires from the safe-character converter 116 converted responses (i.e., the responses in which one or more neutral characters existing in each parameter are converted into one or more safe-character strings), and transmits the converted responses to one of the browser and the transaction servers.

The safe-character converter 116 acquires a response from the inter-service communication controller 115, and determines the destination of the response, and outputs the acquired response to the constituent identifier 117. Then, the safe-character converter 116 acquires from the constituent identifier 117 information on the constituent element in which each parameter contained in the response is used, where the constituent element is identified by the constituent identifier 117. Thereafter, the safe-character converter 116 converts all or part of the one or more neutral characters existing in each parameter contained in the response, into one or more safe-character strings, on the basis of a safe-character conversion table corresponding to the destination of the response and the constituent element in which the parameter contained in the response is used, among the one or more safe-character conversion tables stored in the third table storage 112. Then, the safe-character converter 116 outputs the converted response (i.e., the response in which the one or more neutral characters included in each parameter contained in the response acquired by the safe-character converter 116 are converted into the one or more safe-character strings) to the inter-service communication controller 115.

The constituent identifier 117 identifies the constituent element in which each parameter contained in the response acquired from the safe-character converter 116 is used. For example, the constituent identifier 117 determines in what constituent element (such as a <script> element or a <body> element in an HTML document) each parameter is contained. Then, the constituent identifier 117 informs the safe-character converter 116 of the identified constituent element.

The one or more first table storages 120 store one or more special-character restoration tables, and are prepared in advance in correspondence with the one or more web applications 130 which the web server 100 has. Each of the one or more special-character restoration tables indicates correspondences of one or more neutral characters with one or more special characters usable in the processing performed by the corresponding web application.

The one or more web applications 130 realize functions for letting a user log in to the transaction servers, functions for the message-board service, or the like. When one of the one or more web applications 130 receives a request from the special-character restorer 114, the web application performs login processing, processing for writing a message into a message board, or other processing, according to the received request. Thereafter, the web application generates a response to the browser or one of the transaction servers according to the result of the processing, and outputs the generated response to the inter-service communication controller 115.

Incidentally, the web server 100 can have a plurality of web applications 130 in correspondence with a plurality of services which the web server 100 provides. There is a one-to-one correspondence between the one or more web applications 130 and the one or more first table storage 120. Therefore, in the case where the web server 100 has a plurality of web applications 130, a plurality of special-character restoration tables are stored in the first table storages 120.

### 2.5 Neutral-Character Conversion Table

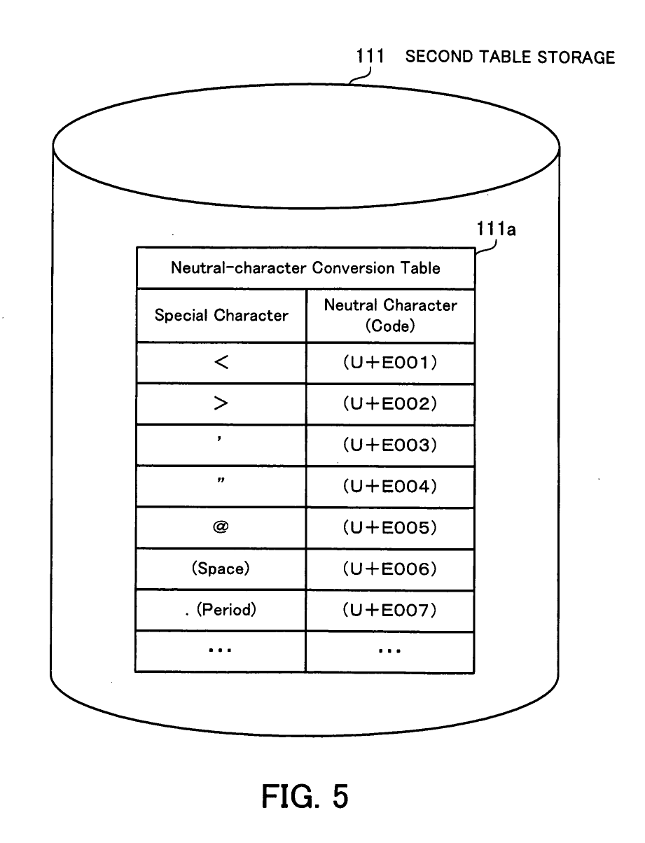

FIG. 5 illustrates an example of a data structure of the neutral-character conversion table. The neutral-character conversion table 111a illustrated in FIG. 5 is stored in the second table storage 111, and is referred to by the neutral-character converter 113 and the special-character restorer 114. The neutral-character conversion table 111a has the column “Special Character” and the column “Neutral Character (Code)”. The information items tabulated in each row of the neutral-character conversion table 111a are associated with each other, and constitute an information set indicating conversion of a special character into a neutral character. Characters which can be control characters in the processing performed by the browser and the transaction servers are set in the column “Special Character”, and neutral characters respectively corresponding to the special characters are set in the column “Neutral Character (Code)”. The neutral characters indicated (in parentheses) in the example of FIG. 5 are ones of the character codes “U+E000” to “U+F8FF” defined in the private-use area in Unicode. For example, as indicated in FIG. 5, the character code “U+E001” is set as a neutral character in correspondence with the special character “<” in the neutral-character conversion table 111a. This means that when the special character “<” is included in a parameter contained in a request received from the terminal 21, the special character “<” is converted into the neutral character represented by the character code “U+E001”.

### 2.6 Special-Character Restoration Table

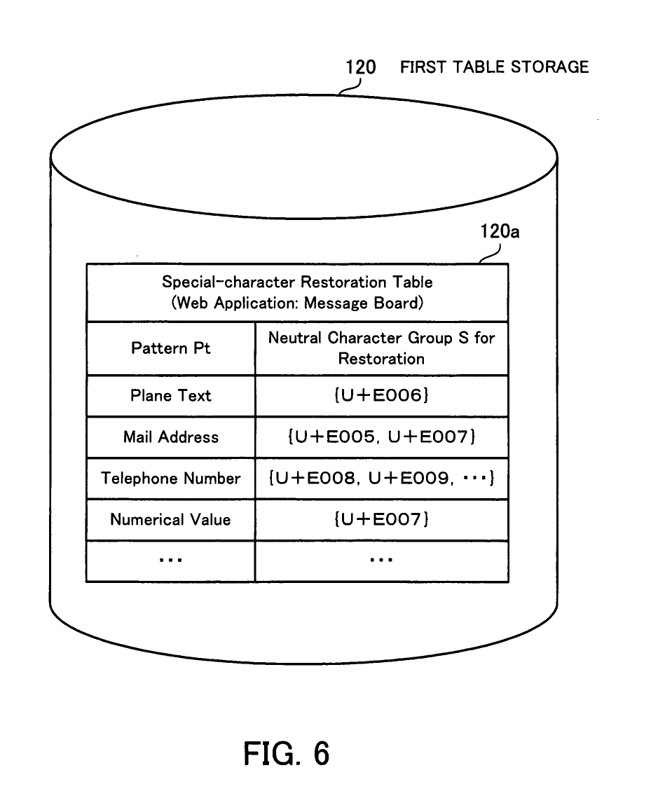

FIG. 6 illustrates an example of a data structure of each special-character restoration table. The special-character restoration table 120a illustrated in FIG. 6 is one of the one or more special-character restoration tables stored in the one or more first table storages 120, and is referred to by the special-character restorer 114. The special-character restoration table 120a has the column “Pattern Pt” and the column “Neutral Character Group S For Restoration”. The information items tabulated in each row of the special-character restoration table 120a are associated with each other, and constitute an information set indicating restoration from a neutral character. Information indicating the location in which each parameter contained in the request is used in the message-board service provided by the corresponding one of the one or more web applications 130 is indicated in the column “Pattern Pt”, and a group S of one or more neutral characters from each of which a special character can be restored are indicated in the column “Neutral Character Group S For Restoration”. For example, as indicated in FIG. 6, the information “Telephone Number” is set in association with the group S of the neutral characters “U+E008”, “U+E009”, . . . in the special-character restoration table 120a. This means that when a parameter contained in the request is used in the information “Telephone Number”, and includes one or more of the neutral characters “U+E008”, “U+E009”, . . . indicated in the column “Neutral Character Group S For Restoration” in correspondence with the information “Telephone Number”, one or more special characters corresponding to the one or more of the neutral characters are restored. The one or more special-character restoration tables are prepared in advance by one or more developers of the one or more web applications so that there is a one-to-one correspondence between the one or more web applications and the one or more special-character restoration tables.

### 2.7 Safe-Character Conversion Table for HTML

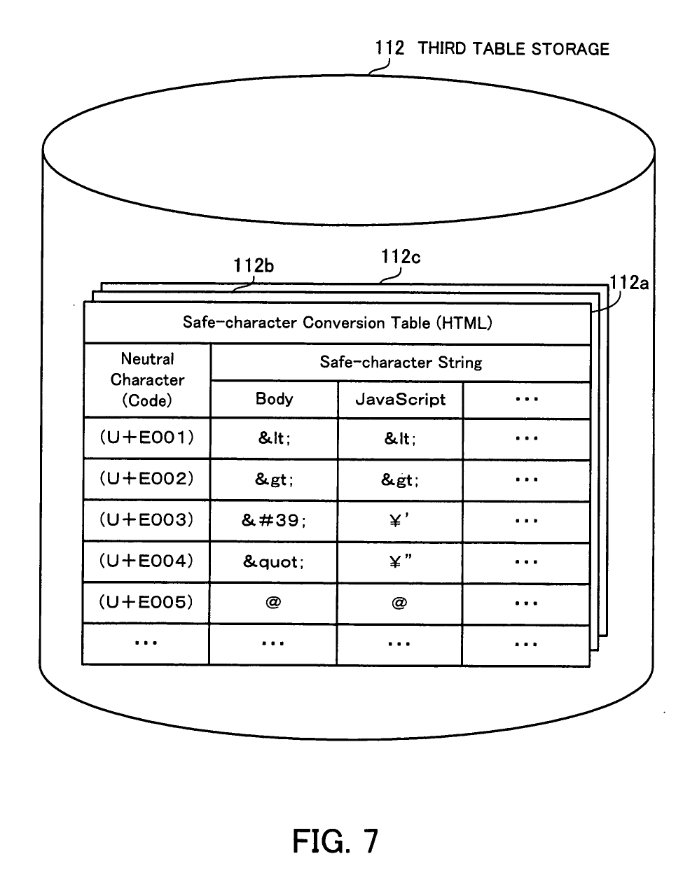

FIG. 7 illustrates an example of a data structure of a safe-character conversion table for HTML. The safe-character conversion table 112a illustrated in FIG. 7 is one of the one or more safe-character conversion tables stored in the third table storage 112, and is referred to by the safe-character converter 116. The safe-character conversion table 112a has the column “Neutral Character (Code)” and the column “Safe-character String (HTML)”. The information items tabulated in each row of the safe-character conversion table 112a are associated with each other, and constitute an information set indicating conversion of a neutral character into a safe-character string. Neutral characters which are to be respectively converted into safe-character strings are set in the column “Neutral Character (Code)”, and safe-character strings respectively corresponding to the neutral characters which are used in each of the constituent elements (such as the body, the JavaScript script, and the like) are set in the column “Safe-character String”. (JavaScript is a registered trademark of Sun Microsystems, Inc.) For example, as indicated in FIG. 7, the safe-character string “&#39;” is set for the body in the HTML document, and the safe-character string “¥” is set for the JavaScript script in the HTML document, in correspondence with the neutral character (code) “U+E003” in the safe-character conversion table 112a. This means that in the case where the neutral character “U+E003” is contained in a response described in an HTML document and transmitted from one of the one or more web applications 130 to the browser, the neutral character (code) “U+E003” is converted into the safe-character string “&#39;” when the neutral character “U+E003” is used in the <body> element in the HTML document, and is converted into the safe-character string “¥′” when the neutral character “U+E003” is used in a constituent element containing a JavaScript script in the HTML document.

### 2.8 Safe-Character Conversion Table for SQL

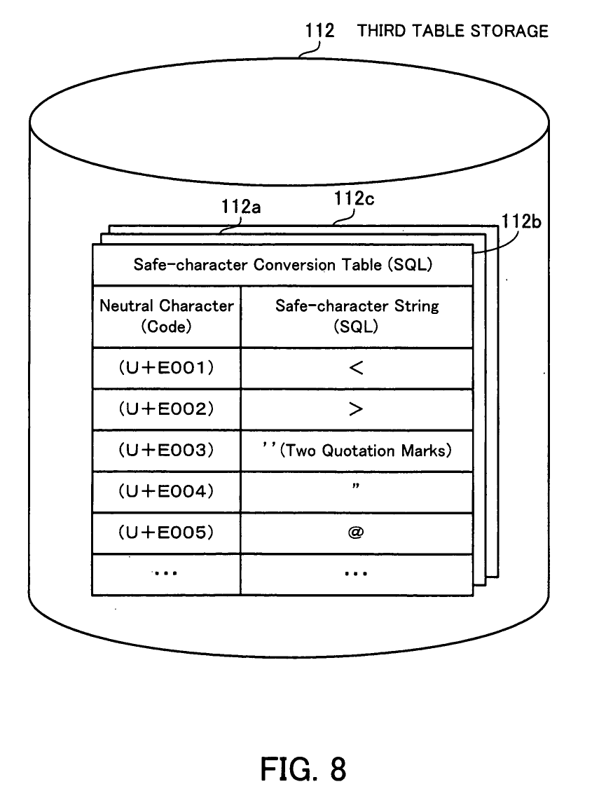

FIG. 8 illustrates an example of a data structure of a safe-character conversion table for SQL. The safe-character conversion table 112b illustrated in FIG. 8 is one of the one or more safe-character conversion tables stored in the third table storage 112, and is referred to by the safe-character converter 116. The safe-character conversion table 112b has the column “Neutral Character (Code)” and the column “Safe-character String (SQL)”. The information items tabulated in each row of the safe-character conversion table 112b are associated with each other, and constitute an information set indicating conversion of a neutral character into a safe-character string. Neutral characters which are to be respectively converted into safe-character strings are set in the column “Neutral Character (Code)”, and safe-character strings which respectively correspond to the neutral characters and are used in an SQL statement are set in the column “Safe-character String”. For example, as indicated in FIG. 8, the safe-character string “‘ ’” is set in correspondence with the neutral character (code) “U+E003” in the safe-character conversion table 112b. This means that the neutral character (code) “U+E003” is converted into the safe-character string “‘ ’ (two single quotation marks)” when the neutral character (code) “U+E003” is contained an SQL statement transmitted from one of the one or more web applications 130 to the DB server 200. Since the single quotation mark “‘” in an SQL statement is recognized as a control character, the single quotation mark “‘” used in a literal in an SQL statement is required to undergo escape processing.

### 2.9 Safe-Character Conversion Table for E-mails

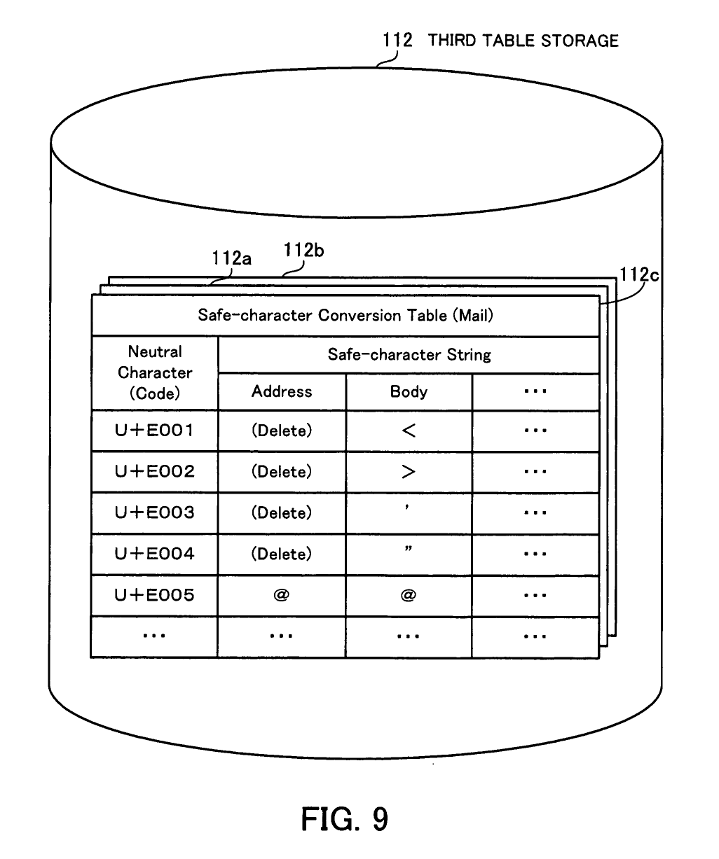

FIG. 9 illustrates an example of a data structure of a safe-character conversion table for e-mails. The safe-character conversion table 112c illustrated in FIG. 9 is one of the one or more safe-character conversion tables stored in the third table storage 112, and is referred to by the safe-character converter 116. The safe-character conversion table 112c has the column “Neutral Character (Code)” and the column “Safe-character String (Mail)”. The information items tabulated in each row of the safe-character conversion table 112c are associated with each other, and constitute an information set indicating conversion of a neutral character into a safe-character string. Neutral characters which are to be respectively converted into safe-character strings are set in the column “Neutral Character (Code)”, and safe-character strings respectively corresponding to the neutral characters which are used in each of the constituent elements (such as the address, the body, and the like) are set in the column “Safe-character String”. For example, as indicated in FIG. 9, the information “Delete” for the mail address and the special character “<” for the body of an e-mail are set in the column “Safe-character String” in correspondence with the neutral character (code) “U+E001” in the safe-character conversion table 112c. This means that the neutral character (code) “U+E001” is deleted when the neutral character (code) “U+E001” is contained in an element constituting an address in a command transmitted from one of the one or more web applications 130 to the mail server 300, and the neutral character (code) “U+E001” is converted into the special character “<” when the neutral character (code) “U+E001” is contained in an element constituting a body of a command transmitted from one of the one or more web applications 130 to the mail server 300.

### 2.10 Data Conversion Processing

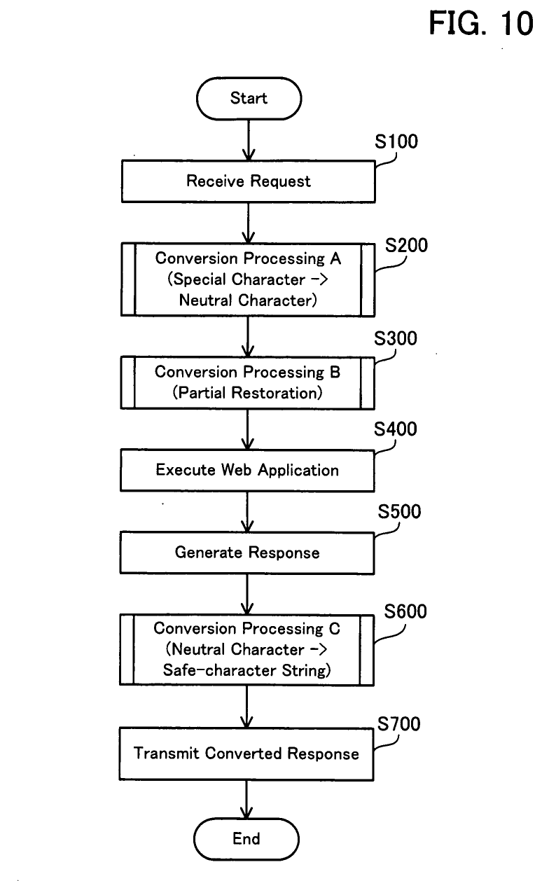

Next, details of data conversion processing performed by the web server 100 having the construction explained above are explained below. FIG. 10 is a flow diagram indicating a sequence of data conversion processing. The processing indicated in FIG. 10 is explained below step by step.

<Step S100> The neutral-character converter 113 acquires a request transmitted from the terminal 21. Specifically, the request is transmitted from the browser of the terminal 21 by use of the GET or POST function, and contains as a parameter each of information items (such as a user ID, a password, an article to be inputted into a message board, and a destination address of an e-mail) according to the service which the user wishes to use.

<Step S200> The neutral-character converter 113 converts one or more special characters included in each parameter contained in the acquired request, into one or more neutral characters, on the basis of the neutral-character conversion table 111a stored in the second table storage 111. Then, the neutral-character converter 113 outputs the converted request (i.e., the request in which the one or more special characters are converted into the one or more neutral characters) to the special-character restorer 114.

<Step S300> The special-character restorer 114 acquires the converted request from the neutral-character converter 113, and restores one or more special characters from all or part of the one or more neutral characters included in the converted request, on the basis of one of the one or more special-character restoration tables (e.g., the special-character restoration table 120a) stored in the one or more first table storages 120 corresponding to one of the one or more web applications 130. Then, the special-character restorer 114 outputs the restored request (i.e., the request in which one or more special characters are restored from all or part of the one or more neutral characters included in the converted request) to the web application.

<Step S400> The web application acquires the restored request from the special-character restorer 114, and performs processing on the basis of the restored request. Specifically, the web application performs login processing for letting a user use the web system, processing for writing a message into a message board, or other processing.

<Step S500> The web application generates a response to one of the browser and the transaction servers according to the result of the processing, and outputs the generated response to the inter-service communication controller 115. At this time, one or more special characters included in each parameter contained in the response are deleted or converted into one or more neutral characters by the web application as needed. Thereafter, the web application outputs the generated response to the inter-service communication controller 115, and then the inter-service communication controller 115 outputs the response to the safe-character converter 116.

<Step S600> The safe-character converter 116 acquires the above response from the inter-service communication controller 115, and converts all or part of one or more neutral characters included in each parameter contained in the response into one or more safe-character strings according to the destination of the response and the constituent element in which the parameter is used. The safe-character converter 116 outputs the converted response (i.e., the response in which all or part of the one or more neutral characters are converted into the one or more safe-character strings) to the inter-service communication controller 115.

<Step S700> The inter-service communication controller 115 acquires the converted response from the safe-character converter 116, and transmits the converted response to one of the browser and the transaction servers as the destination of the response.

As explained above, the web server 100 converts one or more special characters included in each parameter in the request into one or more neutral characters, and then restores all or part of the one or more special characters from the one or more neutral characters according to the web application. In addition, the web server 100 converts all or part of one or more neutral characters included in each parameter in a response generated by the web server 100 into one or more safe-character strings according to the destination of the response and the constituent element in which the parameter in the response is used. Therefore, the security defect due to omission in the settings for escaping is unlikely to occur compared with the conventional technique of setting characters to be escaped for each part of the system in which processing is performed. Thus, it is possible to achieve high security in the system according to the present embodiment.

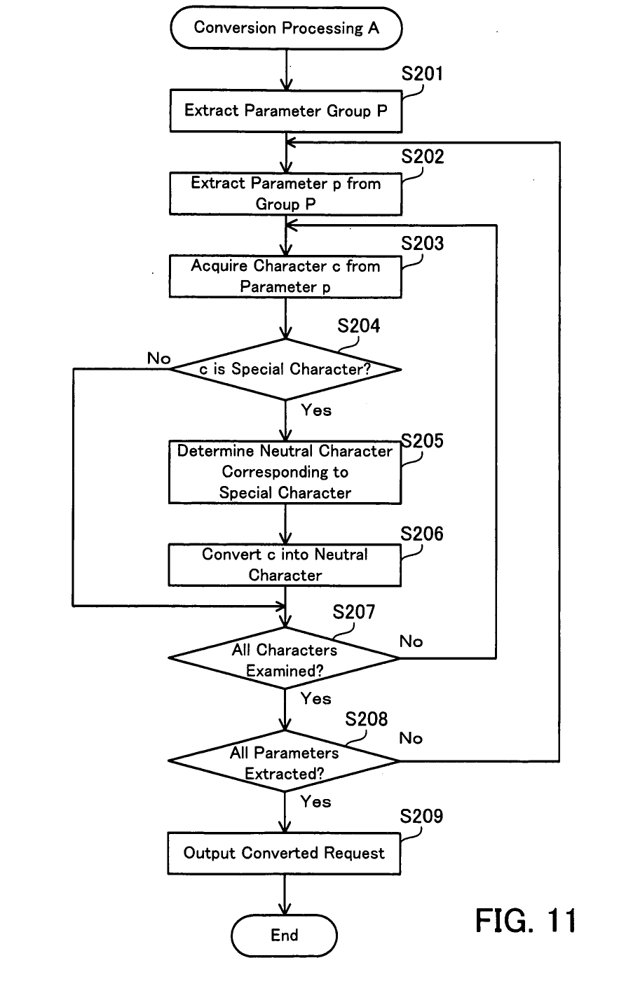

The operations performed in step S200 in FIG. 10 are explained in detail below. FIG. 11 is a flow diagram indicating an exemplary sequence of processing for conversion of one or more special characters into one or more neutral characters in step S200 in FIG. 10. The processing indicated in FIG. 11 is explained below step by step.

<S201> The neutral-character converter 113 extracts a parameter group P from the request. The parameter group P is a group of one or more parameters acquired in step S100, and includes, for example, a user ID, a password, an article to be inputted into a message board, and a destination address of an e-mail.

<S202> The neutral-character converter 113 extracts a parameter p from the parameter group P.

<S203> The neutral-character converter 113 acquires a character c included in the extracted parameter p.

<S204> The neutral-character converter 113 determines whether or not the acquired character c is a special character. For example, it is possible to determine that the acquired character c is a special character when the acquired character c is set in the column “Special Character” in the neutral-character conversion table 111a. When yes is determined, the operation goes to step S205. When no is determined, the operation goes to step S207.

<S205> The neutral-character converter 113 determines the neutral character corresponding to the special character determined in step S204, on the basis of the neutral-character conversion table 111a stored in the second table storage 111.

<S206> The neutral-character converter 113 converts the character c into the neutral character determined in step S205.

<S207> The neutral-character converter 113 determines whether or not the operations in step S204 to S206 are completed for all the characters included in the parameter p. When no is determined, the operation goes to step S203, and another character which is included in the extracted parameter p and on which the operations in step S204 to S206 are not yet completed is acquired as the character c. When yes is determined, the operation goes to step S209.

<S208> The neutral-character converter 113 determines whether or not the extraction in step S202 is completed for all the parameters in the parameter group P. When no is determined, the operation goes to step S202, and another parameter which is included in the parameter group P and is not yet extracted in step S202 is extracted as the parameter p. When yes is determined, the operation goes to step S209.

<S209> The neutral-character converter 113 outputs the converted request (i.e., the request in which all the special characters in all the parameters contained in the request transmitted from the terminal 21 are converted into neutral characters) to the special-character restorer 114.

As explained above, the neutral-character converter 113 converts all the special characters in all the parameters in the request received from the terminal 21 into neutral characters. Thus, even when a parameter contained in the request transmitted from the terminal 21 contains an unauthorized command, the parameter can be converted into one or more Neutral-character strings.

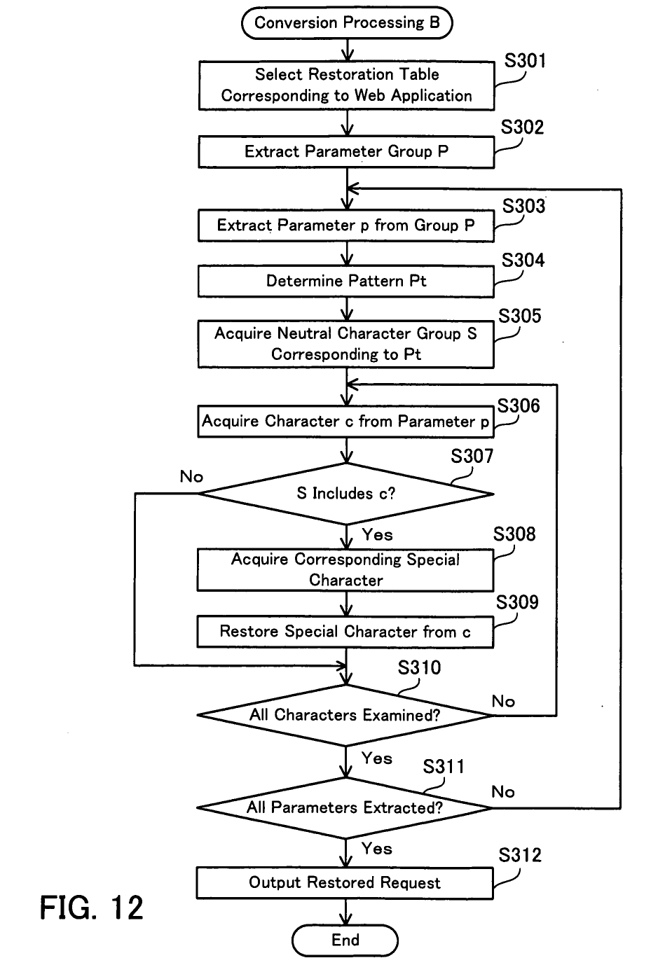

Next, the operations performed in step S300 in FIG. 10 are explained in detail below. FIG. 12 is a flow diagram indicating an exemplary sequence of processing for restoration of one or more special characters from one or more neutral characters in step S300 in FIG. 10. The processing indicated in FIG. 12 is explained below step by step.

<S301> The special-character restorer 114 selects one of the one or more special-character restoration tables stored in the one or more first table storages 120 according to the web application as the destination of the request. In the following explanations with reference to FIG. 12, it is assumed that the special-character restorer 114 selects the special-character restoration table 120a stored in the one or more first table storages 120.

<S302> The special-character restorer 114 extracts a parameter group P from the aforementioned converted request, which is acquired from the neutral-character converter 113.

<S303> The special-character restorer 114 extracts a parameter p from the extracted parameter group P.

<S304> The special-character restorer 114 determines the place of use (the use pattern Pt), in the web application, of the extracted parameter p (i.e., where the extracted parameter p is to be used in the web application) on the basis of the selected special-character restoration table 120a. For example, in the case of the message board, the place of use may be an article to be put up on the message board, the address (e.g., the mail address or telephone number), or the like.

<S305> The special-character restorer 114 acquires from the selected special-character restoration table 120a a group S of one or more neutral characters from each of which a special character can be restored (i.e., one of the information items set in the column “Neutral Character Group S For Restoration” in the selected special-character restoration table 120a) corresponding to the use pattern Pt determined in step S304.

<S306> The special-character restorer 114 acquires a character c from the parameter p.

<S307> The special-character restorer 114 determines whether or not the acquired character c is included the acquired group S of one or more neutral characters (from each of which a special character can be restored). When yes is determined, i.e., when the character c is a neutral character from which a special character can be restored, the operation goes to step S308. When no is determined, i.e., when the character c is not a neutral character from which a special character can be restored, the operation goes to step S310.

<S308> The special-character restorer 114 acquires a special character corresponding to the neutral character c on the basis of the neutral-character conversion table 111a stored in the second table storage 111.

<S309> The special-character restorer 114 restores the special character corresponding to the neutral character c acquired in step S308.

<S310> The special-character restorer 114 determines whether or not the operations in step S307 to S309 are completed for all the characters included in the parameter p. When no is determined, the operation goes to step S306, and another character which is included in the extracted parameter p and on which the operations in step S307 to S309 are not yet completed is acquired as the character c. When yes is determined, the operation goes to step S311.

<S311> The special-character restorer 114 determines whether or not extraction in step S303 is completed for all the parameters in the parameter group P. When no is determined, the operation goes to step S303, and another parameter which is included in the parameter group P and is not yet extracted in step S303 is extracted as the parameter p. When yes is determined, the operation goes to step S312.

<S312> The special-character restorer 114 outputs the restored request (i.e., the request in which all the special characters in all the parameters contained in the request are restored) to the web application.

As explained above, the special-character restorer 114 restores one or more special characters from all or part of the neutral characters included in parameters in the converted request (in which the one- or more special characters are converted into the one or more neutral characters in step S200) according to the necessity in the web application. That is, the restoration processing by the special-character restorer 114 is performed on the safe, neutral characters after the conversion from special characters.

Therefore, even when omission occurs in setting of the special-character restoration table 120a, the request after the special characters are restored does not contain an unauthorized command, so that the security of the processing is high. In addition, the restoration processing is enabled by merely producing the special-character restoration table 120a and storing the special-character restoration table 120a in the one or more first table storages 120. That is, the preparatory setting for the restoration processing is simple. Further, since the one or more web applications 130 may be updated, and some web applications can be added to the one or more web applications 130, it is preferable that the one or more first table storages 120 be arranged in a storage area in which the developer can freely change the settings.

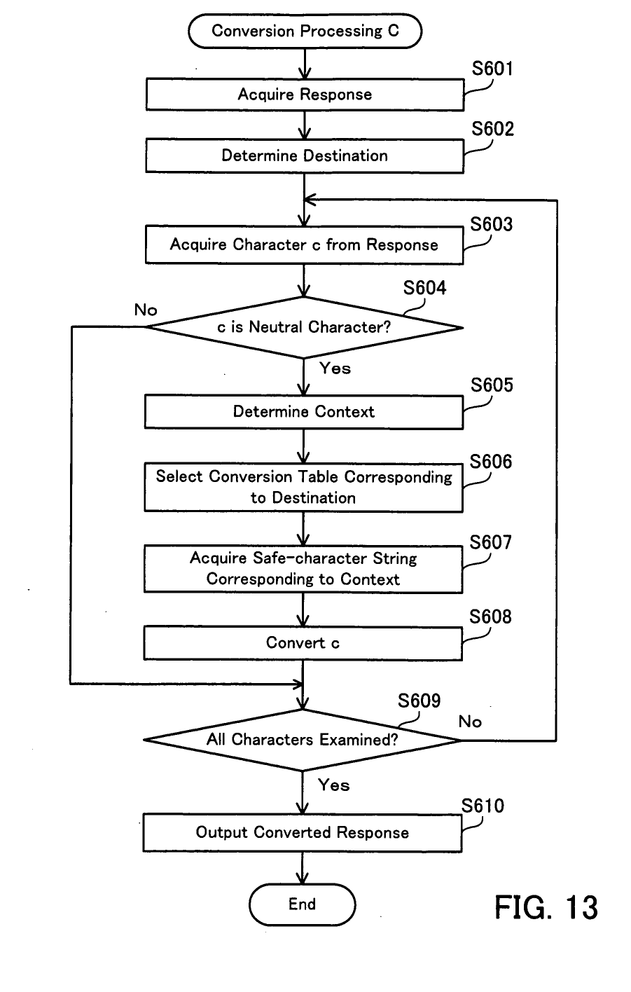

Next, the operations performed in step S600 in FIG. 10 are explained in detail below. FIG. 13 is a flow diagram indicating an exemplary sequence of processing for conversion of one or more neutral characters into one or more safe-character strings in step S600 in FIG. 10. The processing indicated in FIG. 13 is explained below step by step.

<S601> The safe-character converter 116 acquires from the inter-service communication controller 115 a response, which is generated by the web application and is to be transmitted to one of the browser and the transaction servers.

<S602> The safe-character converter 116 determines which of the browser, the DB server 200, and the mail server 300 is the destination of the response.

<S603> The safe-character converter 116 acquires a character c contained in the response.

<S604> The safe-character converter 116 determines whether or not the acquired character c is a neutral character. When yes is determined, the safe-character converter 116 outputs the response to the constituent identifier 117, and the operation goes to step S605. When no is determined, the operation goes to step S609.

<S605> The constituent identifier 117 identifies a constituent element in which the character c is used. For example, in the case where the response is described in an HTML document, the constituent identifier 117 can identify the element (e.g., the <body> element or the <script> element) in which the character c is used in the HTML document by analyzing the response. Then, the constituent identifier 117 informs the safe-character converter 116 of the identified constituent element.

<S606> The safe-character converter 116 selects one of the safe-character conversion tables (including the safe-character conversion tables 112a, 112b, and 112c) stored in the third table storage 112, according to the destination of the response. For example, in the case where the destination of the response is the browser, the safe-character converter 116 selects the safe-character conversion table 112a.

<S607> The safe-character converter 116 acquires from the selected safe-character conversion table 112a safe-character strings corresponding to the constituent element identified in step S605 by the constituent identifier 117.

<S608> The safe-character converter 116 converts the character c into one of the acquired safe-character strings defined in correspondence with the neutral character c. For example, when the destination of the response is determined to be the browser, and the constituent element containing the neutral character “U+E001” is determined to be the JavaScript script, the safe-character converter 116 converts the neutral character “U+E001” into the safe-character string “&lt;” by reference to the safe-character conversion table 112a.

<S609> The safe-character converter 116 determines whether or not the operations in step S604 to S608 are completed for all the characters included in the response. When no is determined, the operation goes to step S603, and another character which is included in the response and on which the operations in step S604 to S608 are not yet completed is acquired as the character c. When yes is determined, the operation goes to step S610.

<S610> The safe-character converter 116 outputs the converted response (i.e., the response in which all or part of the neutral characters in the response are converted) to the inter-service communication controller 115.

As explained above, the safe-character converter 116 can perform processing for escaping to safe-character strings according to the destination of the response generated by the web application, where the processing for escaping is performed on the one or more neutral characters, into which one or more special characters are converted in step S200. Therefore, even when omission occurs in the settings for character conversion, the converted response does not contain an unauthorized command, so that the security of the processing is high. In addition, the conversion processing in step S600 is enabled by merely producing the safe-character conversion tables and storing the safe-character conversion tables in the third table storage 112. That is, the preparatory setting for the conversion processing in step S600 is simple.

### 2.11 Further Details of Processing

Hereinbelow, further details of the processing performed by the data conversion unit 110 in response to a request from the terminal 21 are explained by using concrete examples.

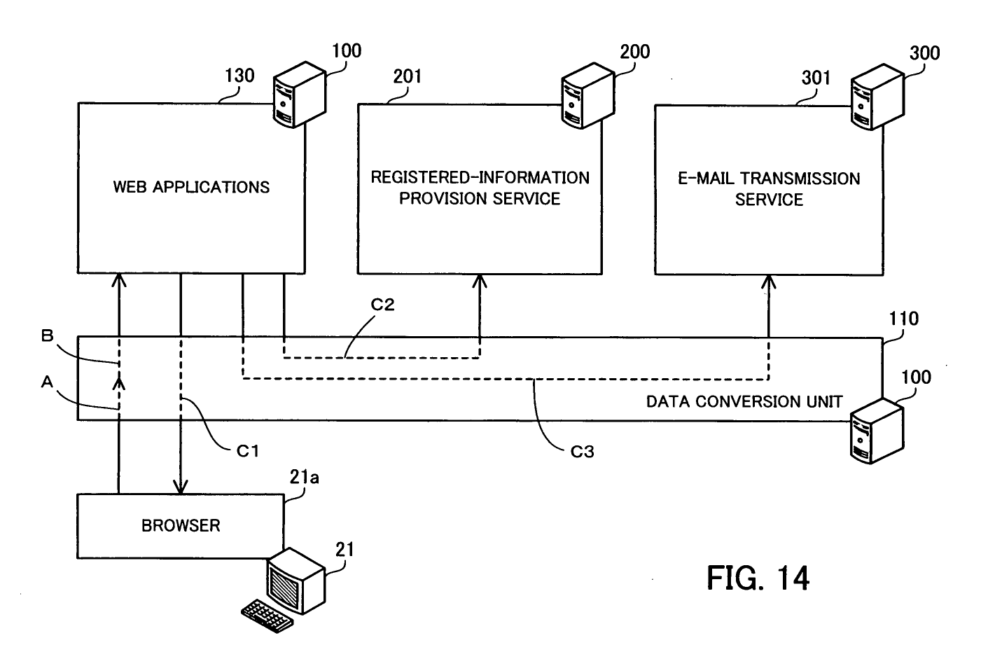

FIG. 14 is a diagram schematically indicating data flows in an example of data conversion processing. In FIG. 14, the elements which are explained before with reference to FIGS. 2 and 4 are indicated by the same reference numbers as FIGS. 2 and 4. The browser 21a is a browser executed by the terminal 21. The registered-information providing service 201 is a service provided by the DB server 200, and provides registered information on users of the web system. The e-mail transmission service 301 is a service provided by the mail server 300, and provides a service of transmitting e-mails.

Further, in FIG. 14, the reference “A” indicates the processing performed by the neutral-character converter 113 as indicated in FIG. 11 for converting special characters into neutral characters. All the special characters contained in the request outputted from the browser 21a are converted into neutral characters by the conversion processing A. The reference “B” indicates the processing performed by the special-character restorer 114 as indicated in FIG. 12 for restoring special characters from all or part of the neutral characters contained in the converted request (i.e., the request in which all the special characters in the request transmitted from the browser 21a are converted into the neutral characters). The special characters which are to be used in processing performed by one of the one or more web applications 130 are restored from the neutral characters contained in the converted request by the restoration processing B. That is, the conversion processing A is performed on the special characters contained in the request transmitted from the browser 21a, and the restoration processing B is performed on the neutral characters contained in the converted request (on which the conversion processing A is already performed).

In addition, in the example of FIG. 14, the references “C1”, “C2”, and “C3” each indicate processing for converting neutral characters into safe-character strings by the safe-character converter 116 as indicated in FIG. 13. The conversion processing C1 is performed on a response, which is generated by one of the one or more web applications 130 and is to be transmitted to the browser 21a. The response is described in an HTML document indicating a web page on which a message board is to be displayed. The conversion processing C2 is performed on an SQL statement, which is generated by one of the one or more web applications 130 and is to be transmitted to the registered-information providing service 201 for referring to user information for login processing or the like. The conversion processing C3 is performed on a transmission command, which is generated by one of the one or more web applications 130 and is to be transmitted to the mail server 300 for transmitting an e-mail.

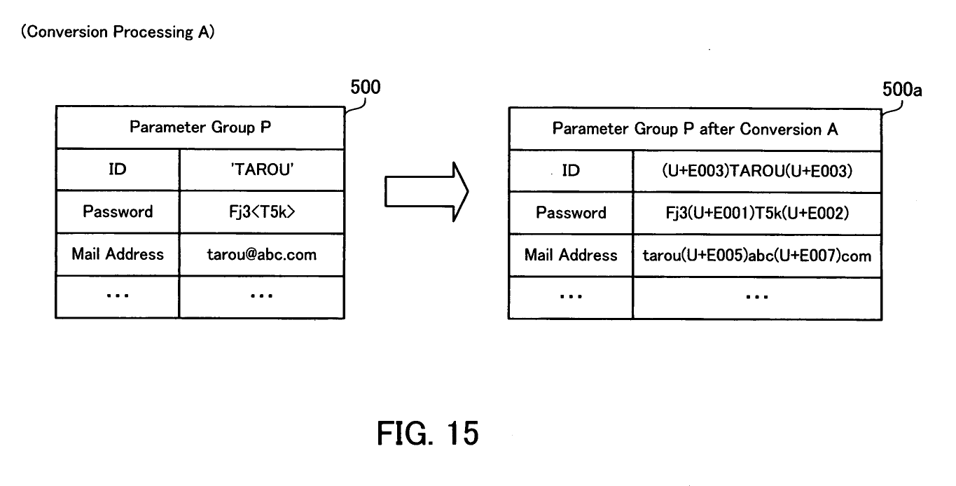

Next, concrete examples of the conversion (or restoration) processing C1, C2, and C3 are explained with reference to FIGS. 15 to 19.

FIG. 15 is a diagram indicating a concrete example of the conversion processing A (indicated in FIG. 14) for converting special characters into neutral characters. The parameter group (P) 500 indicated in the left half of FIG. 15 is a group of parameters contained in the request transmitted from the terminal 21 before the conversion processing A. In the example of FIG. 15, the parameter group 500 contains the character string “‘TAROU’” (i.e., the character string “TAROU” enclosed with single quotation marks “‘”) as an ID, the character string “Fj3<T5k>” as a password, and the character string “tarou@abc.com” as a mail address”. That is, the single quotation marks “‘” contained in the above ID, the symbols “<” and “>” contained in the above password, and the symbols “@” and “.” contained in the above mail address are special characters.

The neutral-character converter 113 converts the above special characters into neutral characters by reference to the neutral-character conversion table 111a, so that the converted parameter group 500a containing the neutral characters is generated. Specifically, the single quotation marks “‘” contained in the above ID are converted into the neutral characters both represented as “U+E003” in Unicode, the symbols “<” and “>” contained in the above password are respectively converted into the neutral characters represented as “U+E001” and “U+E002 in Unicode, and the symbols “@” and “.” contained in the above mail address are respectively converted into the neutral characters represented as “U+E005” and “U+E007” in Unicode. Thus, the parameter group 500a indicated in the right half of FIG. 15 is obtained. The parameters in the parameter group 500a are contained in the converted request (i.e., the request after the conversion processing A is performed on the parameters by the neutral-character converter 113 as above).

As explained above, all the special characters which can be used as control characters in the processing by the browser and the transaction servers are converted into neutral characters. Therefore, it is possible to prevent the request from containing an unauthorized command.

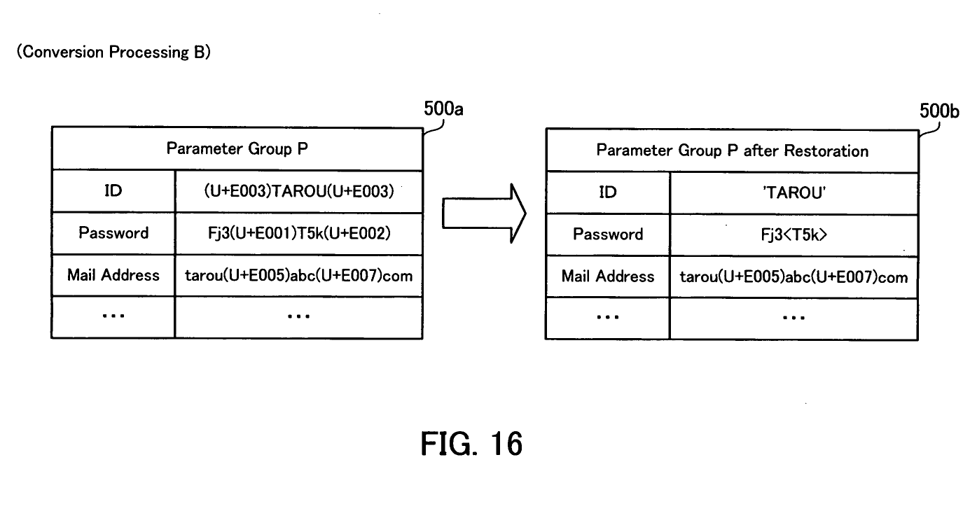

FIG. 16 is a diagram indicating a concrete example of the restoration processing B for restoring special characters from neutral characters. The parameter group 500a indicated in the left side of FIG. 16 is the parameter group 500a indicated in the right half of FIG. 15. The restoration processing B is performed on all or part of the neutral characters included in the parameter group 500a by the special-character restorer 114. The special-character restorer 114 restores all or part of the special characters in the parameter group 500 from the neutral characters included in the parameter group 500a by reference to one of the special-character restoration tables corresponding to the web application and being stored in the one or more first table storages 120. Thus, the parameter group 500b indicated in the right half of FIG. 16 is obtained. The parameters in the parameter group 500b are contained in the restored request (i.e., the request after the restoration processing B is performed on the parameters by the special-character restorer 114 as above).

The special-character restoration table used in the restoration processing B is prepared in advance, for example, for use in the login processing performed by the web application. For the login processing, special characters included in the ID, the password, and the like are restored by the restoration processing B from the neutral characters included in the converted request obtained by the conversion processing A. Specifically, by the restoration processing B, the single quotation marks “‘” contained in the ID are restored from the neutral characters both represented as “U+E003” in Unicode, and the symbols “<” and “>” contained in the password are respectively restored from the neutral characters represented as “U+E001” and “U+E002” in Unicode. However, since the symbols “@” and “.” are not used in the login processing by the web application, the neutral characters represented as “U+E005” and “U+E007” in Unicode are not registered in the corresponding special-character restoration table. Therefore, the symbols “@” and “.” contained in the mail address are not restored from the neutral characters represented as “U+E005” and “U+E007” in Unicode as indicated in the right half of FIG. 16.

As explained above, the special characters in the parameters which are to be used in the processing by the web application are restored from the corresponding neutral characters. The special characters to be restored can be defined in advance by the developer or the like according to the processing by the web application.

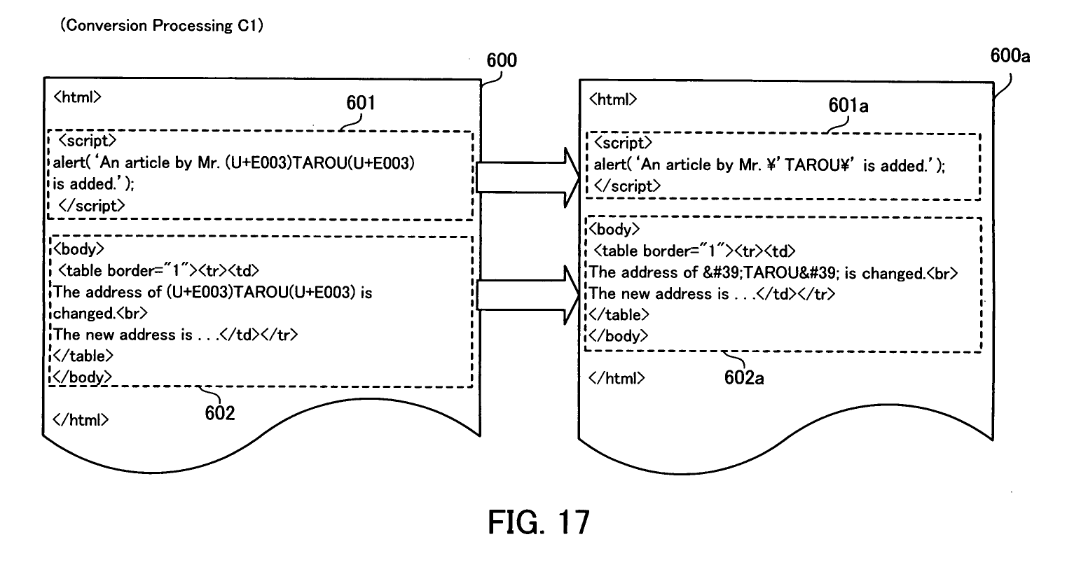

FIG. 17 is a diagram indicating a first concrete example of the conversion processing C1 (indicated in FIG. 14) for converting neutral characters in a response into safe-character strings. The HTML document 600 indicated in the left half of FIG. 17 is a response, which is generated by the web application and is to be transmitted to the terminal 21. In FIGS. 17 to 19, the neutral characters in the responses (including the HTML document, the SQL statement, and the command) are indicated by Unicode symbols in parentheses, although such neutral characters are actually displayed on a computer screen, for example, as a dot “•”.

The HTML document 600 contains a <script> element 601 and a <body> element 602. In the <script> element 601, a script for outputting a dialog box which indicates that a new article is added to the message board is indicated. The <script> element 601 contains two neutral characters both represented by “U+E003”. The <body> element 602 contains an HTML document for outputting to the browser the contents of an article which is newly contributed by a user. The <body> element contains the two neutral characters both represented by “U+E003”.

Before the response is transmitted to the terminal 21, the safe-character converter 116 converts the neutral characters contained in the HTML document 600 into safe-character strings on the basis of the safe-character conversion table 112a illustrated in FIG. 7, so that the converted HTML document 600a indicated in the right half of FIG. 17 is generated. Specifically, the converted HTML document 600a contains a <script> element 601a and a <body> element 602a. The two neutral characters “U+E003” in the <script> element 601 are converted into the two safe-character strings “¥′” in the <script> element 601a, and the two neutral characters “U+E003” in the <body> element 602 are converted into the two safe-character strings “&#39;” in the <body> element 602a. Thus, the neutral characters contained in the HTML document are converted into the safe-character strings. Both of the safe-character strings “¥′” and “&#39;” are converted into the single quotation marks in a screen displayed by the browser.

In the case where the conversion processing Cl is performed as above, it is possible to prevent XSS attack even when a response in which an inputted parameter is inserted in a <body> element as the <body> element 602 is generated and transmitted to the browser. This is because even when the inputted parameter includes an unauthorized script, all the special characters which can constitute the unauthorized script are converted into neutral characters. Further, since the neutral characters are converted into safe-character strings as needed, the browser can appropriately display the inputted parameter on the screen of the terminal 21.

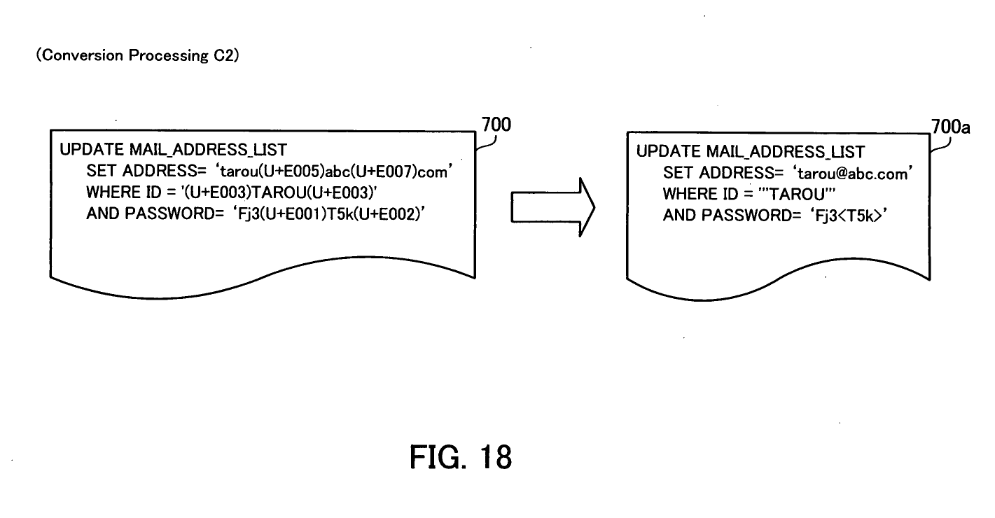

FIG. 18 is a diagram indicating a second concrete example of the conversion processing C2 (indicated in FIG. 14) from neutral characters in a response into safe-character strings. The SQL statement 700 indicated in the left half of FIG. 18 is a response, which is generated by the web application and is to be transmitted to the DB server 200. The SQL statement 700 contains the neutral characters “U+E005”, “U+E007”, “U+E003”, “U+E001”, and “U+E002”.

Before the response is transmitted to the DB server 200, the safe-character converter 116 converts the neutral characters contained in the SQL statement 700 into safe-character strings on the basis of the safe-character conversion table 112b illustrated in FIG. 8, so that the converted SQL statement 700a indicated in the right half of FIG. 18 is generated. Specifically, the neutral characters “U+E005”, “U+E007”, “U+E003”, “U+E001”, and “U+E002” in the SQL statement 700 are respectively converted into the safe-character strings “@”, “. (period)”, “‘ ’”, “<”, and “>”. Since the single quotation mark “‘” is used as a control character in the SQL statement, the single quotation mark “‘” is required to be escaped as above. Thus, the neutral characters included in the SQL statement are converted into the safe-character strings.

In the case where the conversion processing C2 is performed as above, it is possible to prevent SQL injection even when a response in which an inputted parameter is inserted in an SQL statement is generated and transmitted to the DB server 200. This is because even when the inputted parameter includes an unauthorized command, all the special characters in the inputted parameter which can constitute the unauthorized command are converted into neutral characters. Further, since the neutral characters in the SQL statement are converted into safe-character strings as needed, the DB server 200 can appropriately execute the SQL statement containing the inputted parameter.

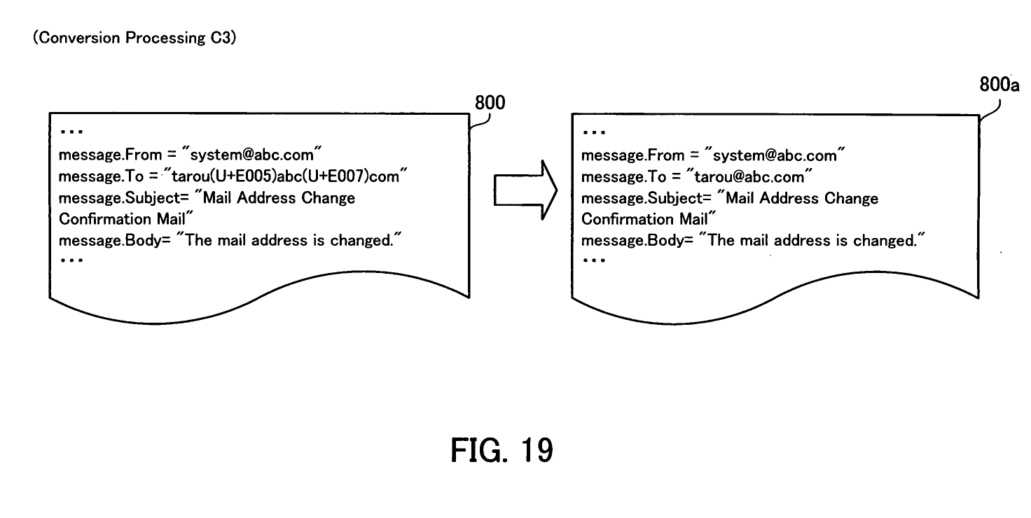

FIG. 19 is a diagram indicating a third concrete example of the conversion processing C3 (indicated in FIG. 14) from neutral characters in a response into safe-character strings. The e-mail-transmission command 800 indicated in the left half of FIG. 19 is a command to transmit an e-mail, which is generated by the web application and is to be transmitted to the mail server 300. The e-mail-transmission command 800 contains the neutral characters “U+E005” and “U+E007”.

Before the response is transmitted to the mail server 300, the safe-character converter 116 converts the neutral characters contained in the e-mail-transmission command 800 into safe-character strings on the basis of the safe-character conversion table 112c illustrated in FIG. 9, so that the converted e-mail-transmission command 800a indicated in the right half of FIG. 19 is generated. Specifically, the neutral characters “U+E005” and “U+E007” in the e-mail-transmission command 800 are respectively converted into the safe-character strings “@” and “. (period)”. Thus, the neutral characters included in the e-mail-transmission command are converted into the corresponding safe-character strings indicated in the safe-character conversion table 112c illustrated in FIG. 9.

As explained above, the safe-character converter 116 performs processing of responses generated by web applications, for escaping to safe-character strings according to the destinations of the responses. Specifically, the conversion processing by the safe-character converter 116 is performed on the safe, neutral characters which are generated by the conversion from special characters. Therefore, even when omission occurs in the settings for character conversion, the converted response does not contain an unauthorized command, so that the security of the processing is high. In addition, the processing for conversion into safe-character strings is enabled by merely producing the safe-character conversion tables (including the safe-character conversion tables 112a, 112b, and 112c) and storing the safe-character conversion tables in the third table storage 112. That is, the preparatory setting for conversion into safe-character strings is simple.

### 2.12 Variations of Embodiment

Although the transaction servers explained above are the DB server 200 and the mail server 300, the system according to the present embodiment may comprise one or more other servers which provide other services.

Alternatively, the functions of the data conversion unit 110 according to the present embodiment may be realized in a device other than the web server 100. For example, the functions of the data conversion unit 110 may be realized in the firewall 31.

Although Unicode is used for representing the characters in the explained examples, it is possible to use another character system.

### 3. Recording Medium Storing Program

The above processing functions of the data conversion device can be realized by a computer. In this case, a program (i.e., a data conversion program) describing details of processing for realizing the functions which the data conversion device should have is provided. When the computer executes the program, the above processing functions of the data conversion device can be realized on the computer.

The program describing the details of the processing can be stored in a recording medium which can be read by the computer. The recording medium may be a magnetic recording device, an optical disk, an optical magnetic recording medium, a semiconductor memory, or the like. The magnetic recording device may be a hard disk drive (HDD), a flexible disk (FD), a magnetic tape, or the like. The optical disk may be a DVD (Digital Versatile Disk), a DVD-RAM (Random Access Memory), a CD-ROM (Compact Disk Read Only Memory), a CD-R (Recordable)/RW (ReWritable), or the like. The optical magnetic recording medium may be an MO (Magneto-Optical Disk) or the like.

In order to put the program into the market, for example, it is possible to sell a portable recording medium such as a DVD or a CD-ROM in which the program is recorded. Alternatively, it is possible to store the program in a storage device belonging to a server computer, and transfer the program to another computer through a network.

The computer which executes the program stores the program in a storage device belonging to the computer, where the program is originally recorded in, for example, a portable recording medium, or is initially transferred from the server computer. The computer reads the program from the storage device, and performs processing in accordance with the program. Alternatively, the computer may directly read the program from the portable recording medium for performing processing in accordance with the program. Further, the computer can sequentially execute processing in accordance with each portion of the program every time the portion of the program is transferred from the server computer.

### 4. Advantage of Embodiment

As explained above, in the data conversion program, the data conversion device, and the data conversion process according to the present embodiment, it is possible to perform escape processing according to the destination without omission.

### 5. Additional Matters

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention have been described in detail, it should be understood that various changes, substitutions and alterations could be made hereto without departing from the spirit and scope of the invention.

What is claimed is:

1. A computer-readable recording medium storing a data conversion program which is executed by a computer and makes the computer realize a data conversion device for converting data for use in one or more first-stage service provision units and a second-stage service provision unit which performs processing in response to a request from one of the one or more first-stage service provision units, said data conversion device comprises:
a neutral-character conversion storage which stores neutral-character conversion information indicating correspondence of one or more special characters with one or more neutral characters which are predetermined and used by none of said one or more first-stage service provision units and said second-stage service provision unit;
a safe-character conversion storage which stores safe-character conversion information indicating correspondence of each of one or more neutral characters with a predetermined string of one or more safe characters which is to be used for character reference by the second-stage service provision unit;
a first conversion unit which receives input data, generates first converted data by converting one or more special characters included in the input data into one or more neutral characters on the basis of the neutral-character conversion information stored in said neutral-character conversion storage, and outputs the first converted data to said one of the one or more first-stage service provision units; and
a second conversion unit which receives processed data generated by said one of the one or more first-stage service provision units by processing of said first converted data, generates second converted data by converting each of all or part of one or more neutral characters included in the processed data into a string of one or more safe characters on the basis of the safe-character conversion information stored in said safe-character conversion storage, and outputs the second converted data to said second-stage service provision unit.

2. The computer-readable recording medium according to claim 1, wherein said processed data has a data structure constituted by constituent elements, and said safe-character conversion information is set in said safe-character conversion storage for each of the constituent elements, and said second conversion unit determines a constituent element in which each of said one or more neutral characters included in the processed data is contained, and converts each of the one or more neutral characters included in the processed data into a string of one or more safe characters on the basis of the safe-character conversion information for one of the constituent elements in which said each of said one or more neutral characters is contained.

3. The computer-readable recording medium according to claim 1, wherein said data conversion device further comprises a special-character restoration storage which stores special-character restoration information defining one or more special characters which can be restored from one or more neutral characters, and said first conversion unit further restores one or more special characters from all or part of one or more neutral characters included in said first converted data on the basis of said special-character restoration information and said neutral-character conversion information before the first converted data is outputted to said one of the one or more first-stage service provision units.

4. The computer-readable recording medium according to claim 3, wherein said one or more first-stage service provision units are a plurality of service provision units, said special-character restoration information is defined for each of the plurality of service provision units, and said first conversion unit further selects the special-character restoration information defined for one of the plurality of service provision units as a destination of said first converted data, and restores all or part of one or more special characters corresponding to said one or more neutral characters included in the first converted data on the basis of the selected special-character restoration information.

5. The computer-readable recording medium according to claim 1, wherein neutral characters handled by said data conversion device can be represented by character codes for which characters are undefined in said one or more first-stage service provision units and said second-stage service provision unit.

6. The computer-readable recording medium according to claim 1, wherein strings of one or more safe characters defined in said safe-character conversion information include an escape character, which realizes escaping of one or more special characters according to processing performed by said second-stage service provision unit.

7. A data conversion device for converting data for use in one or more first-stage service provision units and a second-stage service provision unit which performs processing in response to a request from one of the one or more first-stage service provision units, comprising:
a neutral-character conversion storage which stores neutral-character conversion information indicating correspondence of one or more special characters with one or more neutral characters which are predetermined and used by none of said one or more first-stage service provision units and said second-stage service provision unit;
a safe-character conversion storage which stores safe-character conversion information indicating correspondence of each of one or more neutral characters with a predetermined string of one or more safe characters which is to be used for character reference by the second-stage service provision unit;
a first conversion unit which receives input data, generates first converted data by converting one or more special characters included in the input data into one or more neutral characters on the basis of the neutral-character conversion information stored in said neutral-character conversion storage, and outputs the first converted data to said one of the one or more first-stage service provision units; and
a second conversion unit which receives processed data generated by said one of the one or more first-stage service provision units by processing of said first converted data, generates second converted data by converting each of all or part of one or more neutral characters included in the processed data into a string of one or more safe characters on the basis of the safe-character conversion information stored in said safe-character conversion storage, and outputs the second converted data to said second-stage service provision unit.

8. A data conversion process for converting data for use in one or more first-stage service provision units and a second-stage service provision unit which performs processing in response to a request from one of the one or more first-stage service provision units, comprising:
receiving input data, generating first converted data by converting one or more special characters included in the input data into one or more neutral characters on the basis of neutral-character conversion information stored in a neutral-character conversion storage, and outputting the first converted data to said one of the one or more first-stage service provision units; and
receiving processed data generated by said one of the one or more first-stage service provision units by processing of said first converted data, generating second converted data by converting each of all or part of one or more neutral characters included in the processed data into a string of one or more safe characters on the basis of safe-character conversion information stored in a safe-character conversion storage, and outputting the second converted data to said second-stage service provision unit;
where said neutral-character conversion information indicates correspondence of one or more special characters with one or more neutral characters which are predetermined and used by none of said one or more first-stage service provision units and said second-stage service provision unit, and said safe-character conversion information indicates correspondence of each of one or more neutral characters with a predetermined string of one or more safe characters which is to be used for character reference by the second-stage service provision unit.
